(19) United States
(12) Patent Application Publication
(10) Pub. No.: US 2009/0071414 A1
(43) Pub. Date: Mar. 19, 2009

(54) Wearable sound system for an animal

(76) Inventor: Lisa Caputo, Jamaica, NY (US)

Correspondence Address: BRUCE L. ADAMS, ESQ., 17 BATTERY PLACE - SUITE 1231, NEW YORK, NY, 10004, US

(21) Appl. No.: 11/901,127

(22) Filed: Sep. 14, 2007

(51) Int. Cl. A01K 15/02

(52) U.S. Cl. 119/719

(57) ABSTRACT

A wearable sound system for an animal such as a dog, a cat, or a horse includes a manually or wirelessly controlled programmable source of audible signals and at least two speakers that are coupled to an article (e.g., a collar, a harness, or a hood) wearable by the animal. Each speaker is adapted to project a sound content of the audible signals towards an immediate vicinity of an ear of the animal. The audible signals may include commands, training signals, stress-relieving signals, or a combination thereof.

### BACKGROUND OF THE INVENTION

1. Field of the Invention

The present disclosure relates generally to the field of sound systems for animals and, more specifically, to wearable sound systems for training, controlling or comforting animals.

2. Background Information

In processes of training or controlling animals and, in particular, dogs, cats, or horses, it is desirable to communicate to an animal the commands and training signals at distances that exceed a range of direct voice communications, as well as be able to communicate comforting stress-relieving audible signals, such as desensitization sounds or specific music.

Presently, these goals are achieved by providing the animal with a wearable sound system having a speaker located on an animal's collar. However, in many environments characterized by high levels of inherent audible noises (for example, public gatherings, construction sites, means of mass transportation, thunderstorms, and the like), such systems have limited effectiveness.

There is therefore a need in the art for improved wearable sound systems for animals.

### SUMMARY OF THE INVENTION

Wearable sound systems for animals (for example, dogs, cats, or horses) are described herein. In one embodiment, such a system includes an article wearable by the animal, a programmable source of audible signals detachably coupled to the article, and at least two speakers. Each speaker is coupled to the article in a region proximate to an ear of the animal and adapted to project a sound content of the audible signals towards an immediate vicinity of the ear and, specifically, forward or around the ear of the animal.

In exemplary designs, the inventive sound systems comprise programmable sources of audible signals having manual or wireless controls and adapted for storing, playing, and deleting files containing commands, training signals, stress-relieving signals, or a combination thereof. Various aspects and embodiments of the disclosure are described in further detail below.

The Summary of the Invention is neither intended nor should it be construed as being representative of the full extent and scope of the present disclosure, which these and additional aspects will become more readily apparent from the detailed description, particularly when taken together with the appended drawings.

### BRIEF DESCRIPTION OF THE DRAWINGS

FIG. 1 is a schematic perspective view of a wearable sound system for an animal in one embodiment of the disclosure;

FIGS. 2A-2B are schematic perspective views of a wearable sound system for an animal in another embodiment of the disclosure;

FIG. 3 is a schematic perspective view illustrating an application of the wearable sound system of FIGS. 2A-2B;

FIG. 4 is a schematic diagram of the wearable sound systems of the embodiments of the disclosure having wirelessly controlled programmable sources of audible signals;

FIG. 5A is a schematic perspective view of a wearable sound system for an animal in yet another embodiment of the disclosure; and

FIG. 5B is a schematic perspective view illustrating an application of the wearable sound system of FIG. 5A.

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the disclosure and, as such, should not be considered as limiting the scope of the disclosure that may admit to other equally effective embodiments. It is contemplated that features or steps of one embodiment may be beneficially incorporated in other embodiments without further recitation.

### DETAILED DESCRIPTION OF THE PREFERRED EMBODIMENTS

The term “exemplary” is used herein to mean “serving as an example, instance, or illustration.” Any embodiment or design described herein as “exemplary” or “alternative” is not necessarily to be construed as preferred or advantageous over other embodiments or designs.

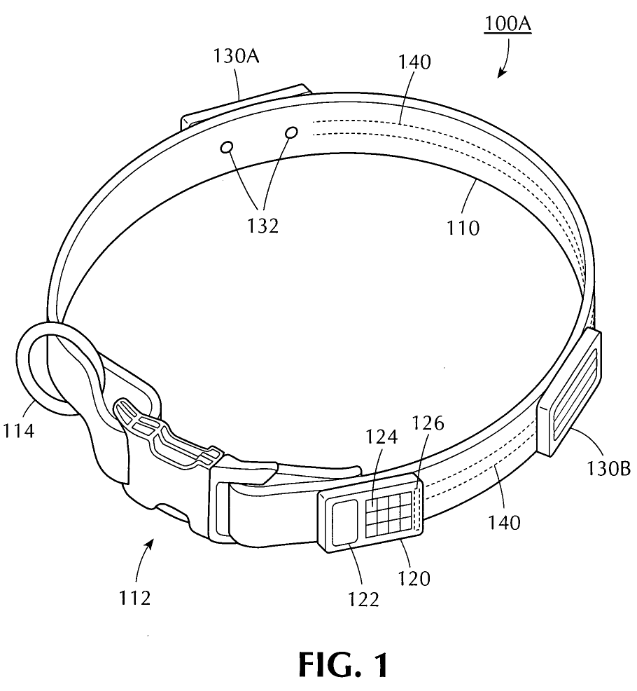

Referring to the figures, FIG. 1 depicts a schematic perspective view of a wearable sound system 100A in accordance with one embodiment of the present disclosure. The system 100A generally comprises a collar 110, a programmable source 120 of audible signals, a plurality of speakers or micro/mini-speakers 130A and 130B, and a wiring network 140 (shown in phantom) coupling the speakers 130A, 130B to the programmable source 120. Hereafter, the term “speaker” is used interchangeably in reference to speakers and micro/mini-speakers.

The collar 110 is adapted for fastening around a neck of an animal such as a dog, a cat, or a horse, among other animals. Ends of the collar 110 are terminated with a latch 112, such as a buckle (as shown), a clasp, or the like fastener. In the depicted embodiment, the collar 110 also includes a retaining ring 114 adapted for connecting the collar to a leash (not shown). Conductors and terminals of the wiring network 140 are generally embedded in material(s), or lining, of the collar 110 or otherwise protected from the animal or environment.

In one embodiment, the speakers 130A and 130B are integrally affixed to the collar 110 (illustratively, using fasteners 132) and connected to the wiring network 140. Each of the speakers 130A and 130B is disposed in a region that, when the collar 110 is fastened on the animal, is located proximate to an ear of the animal, as well as adapted to project towards an immediate vicinity of the ear a sound content of the audible signals received, via the wiring network 140, from the programmable source 120. Specifically, the speakers 130A and 130B project the sound content of the audible signals in a region located forward (i.e., in front of) or around the respective ear of the animal.

In alternate embodiments (not shown), a plurality of the speakers 130A, 130B (for example, 2-6 speakers) may be disposed on the collar 110 proximate to one or both ears of the animal. Additionally or alternatively, at least some of the speakers 130A, 130B may include a protective cover or be embedded in material(s) of the collar 110.

The programmable source 120 is removably coupled to the collar 110 (for example, using, a retaining clip or a sheath (both not shown), among other fasteners) and detachably connected to the wiring network 140. In one embodiment, the programmable source 120 is disposed proximate to the latch 112 and opposite to the retaining ring 114.

The programmable source 120 is generally a digital audio component such as a digital audio player (for example, MP3 player and the like) that is adapted for storing, playing, and deleting files embodying audible signals. Typically, the audible signals comprise commands, training signals, stress-relieving signals (for example, music, recordings of an animal owner's voice, animal sounds, desensitization sounds, and the like), or a combination thereof. The respective files may be stored (for example, downloaded) in an internal memory of the programmable source 120, such as a memory chip or the like electronic memory device associated with the programmable source 120.

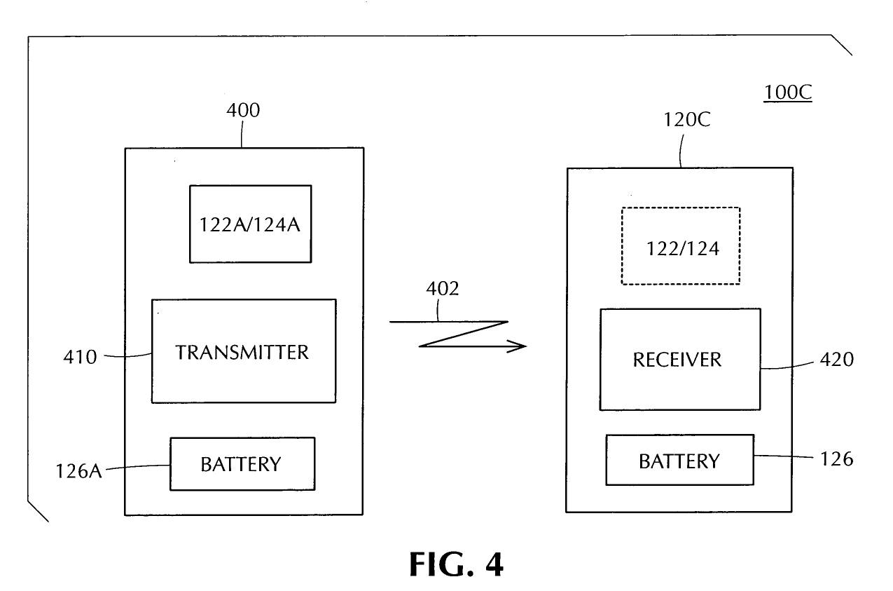

In one embodiment, the programmable source 120 comprises a means of manual control, including a display 122 and controls 124 (for example, a liquid crystal display (LCD) 122 and a plurality of pushbuttons or knobs 124), a battery 126 (shown in phantom), and a connector (not shown) for coupling to the wiring network 140. In operation, the battery 126, either a replaceable or re-chargeable battery, provides power to the programmable source 120 and the speakers 130A, 130B. In other embodiments (discussed below in reference to FIG. 4), alternatively or additionally, the programmable source 120 may include a means of wireless control.

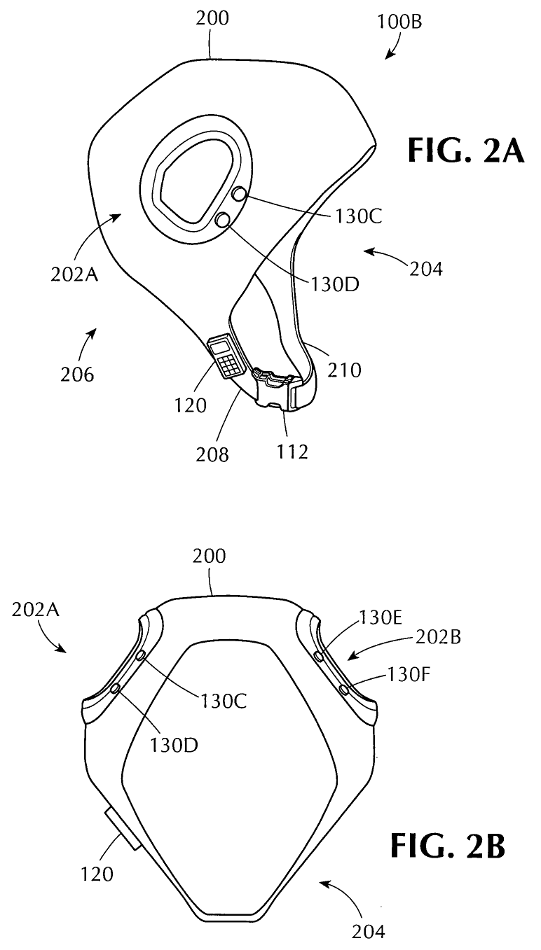

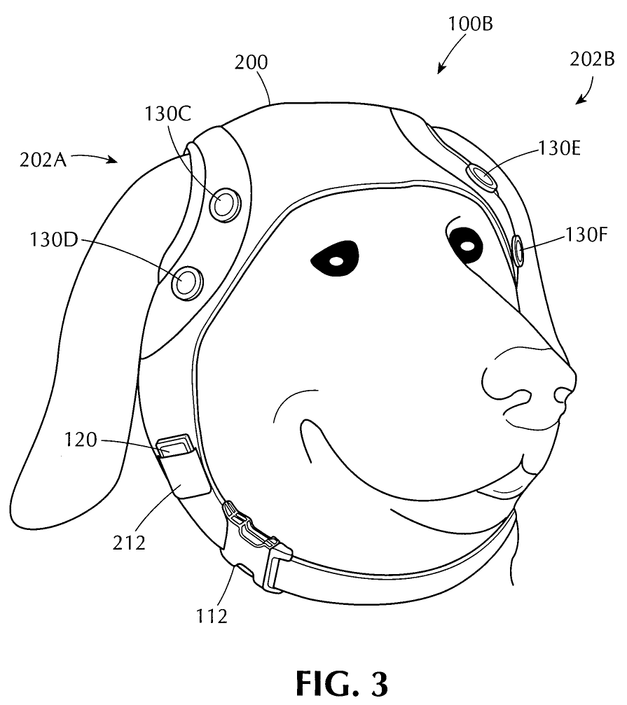

Referring to FIGS. 2A-2B and 3, in a wearable sound system 100B according to another embodiment of the disclosure, the programmable source 120, a plurality of speakers 130C-130F, and the wiring network 140 (not shown) are disposed on a hood 200 fastenable around a head of the animal.

The hood 200 has openings 202A-202B for receiving therethrough the ears of the animal, openings 204 and 206 for front and rear portions of the animal's head, respectively, and straps 208, 210 terminated with mating elements of a latch 112. In the depicted embodiment, the programmable source 120 is illustratively disposed in a sheath 212 disposed on the strap 208 in proximity to the latch 112.

Referring to FIG. 3, the speakers 130C-130F are disposed at a periphery of the openings 202A and 202B such that each of the speakers projects a sound content of the audible signals received from the programmable source 120 towards front orifices of the animal's ears, i.e., in a region located in an immediate vicinity to and forward of the respective ear of the animal. In operation, closeness of the speakers 130C-130F to the ears of the animal increases effectiveness of the wearable sound system 100B in delivering of the intended sound content and blocking out external/environmental noise or sounds.

Referring to FIG. 4, in a further embodiment, a wearable sound system 100C includes a remote controller 400 adapted to operate a programmable source 120C via a wireless communication link 402. In this embodiment, the remote controller 400 and programmable source 120C are provided with a wireless transmitter 410 and a wireless receiver 420, respectively. In operation, a user of the remote controller 400 enables, via the wireless communication link 402, functions of the programmable source 120C.

Illustratively, the remote controller 400 includes a display 122A, controls 124A, and a battery 126A that are similar to the display 122, controls 124 and battery 126 of the programmable source 120C. Alternatively, in this embodiment the programmable source 120C may, optionally, have no display, controls, or both.

Preferably, the volume of the sound content of the audible signals received from the programmable source 120C is variable and can be controlled (automatically or manually) either by one of the controls 124 on the programmable source 120C, one of the controls 124A on the remote controller 400, or both. For example, the volume of the sound content may be varied as a function of the ambient noise level experienced by the animal. As an example, the volume may be maintained at a low level during relatively quiet conditions, and elevated during relatively noisy conditions (e.g., when the dog is running, during wind and/or rain, and the like) or in many environments characterized by high levels of inherent audible noises (e.g., public gatherings, construction sites, means of mass transportation, thunderstorms, and the like). The volume controller also preferably includes a volume setting where the sound content is audible only to the animal.

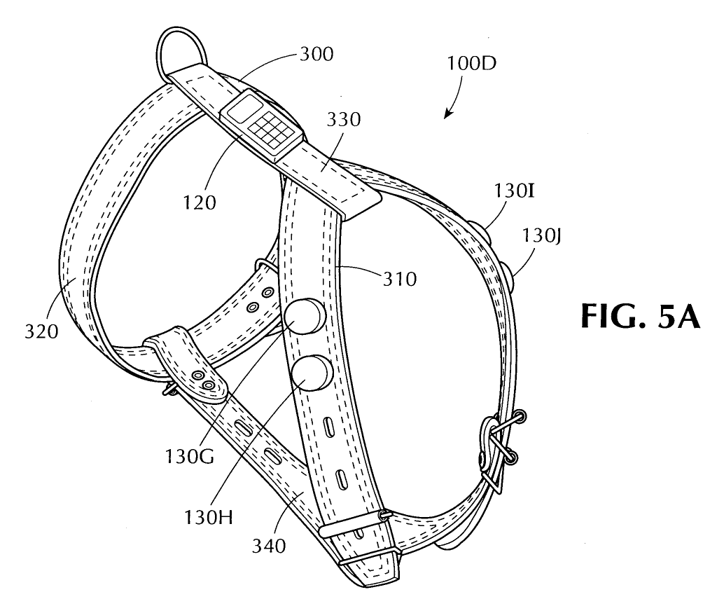

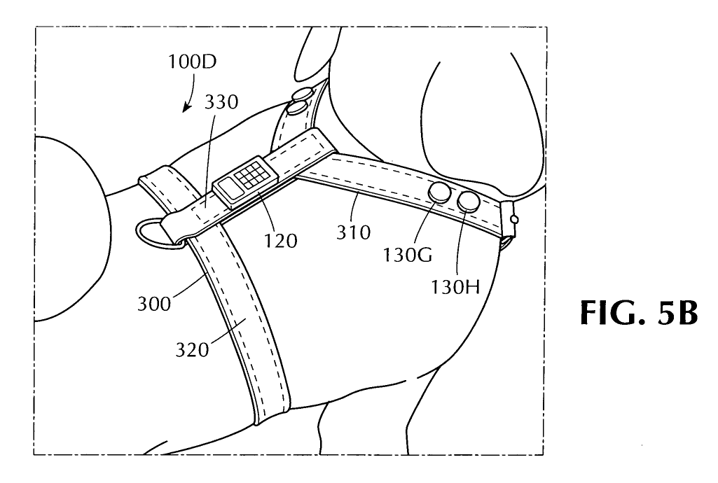

Referring to FIGS. 5A-5B, in a wearable sound system 100D according to another embodiment of the disclosure, the programmable source 120, a plurality of speakers 130G-130J, and the wiring network 140 (not shown) are disposed on a harness 300 that fits around the head and body of the animal.

The harness 300 is of conventional construction and has a first strap portion 310 that fits around the head of the animal, a second strap portion 320 that fits around a mid-section of the animal's body, and third and fourth strap portions 330, 340 interconnecting the first and second strap portions 310, 320 and that extend on upper and lower portions, respectively, of the animal's body.

In the depicted embodiment, the programmable source 120 is removably coupled to the third strap portion 330 of the harness (for example, using, a retaining clip or a sheath (both not shown), among other fasteners) and detachably connected to the wiring network 140. The speakers 130G-130J are affixed to opposite sides of the first strap portion 310 and connected to the wiring network 140. Each of the speakers 130G-130J is disposed in a region that, when the harness 300 is fastened on the animal, is located proximate to an ear of the animal, as well as adapted to project towards an immediate vicinity of the ear a sound content of the audible signals received, via the wiring network 140, from the programmable source 120. Specifically, the speakers 130G-130J project the sound content of the audible signals in a region located forward (i.e., in front of) or around the respective ear of the animal. In operation, closeness of the speakers 130G-130J to the ears of the animal increases effectiveness of the wearable sound system 100D in delivering of the intended sound content and blocking out external/environmental noise or sounds.

By the foregoing construction, since the harness 300 is securely fastened around the head and body of the animal, shifting of the first strap portion 310 of the harness 300 around the neck of the animal (e.g., during movement of the animal) is substantially restricted. As a result, during such movement of the animal, the speakers 130G-130J mounted on the first strap portion 310 will substantially remain in the desirable positions proximate to the ears of the animal, as described above.

Other features described above for the embodiments of FIGS. 1, 2A-2B, 3 and 4 are also applicable to the embodiment shown in FIGS. 5A-5B. For example, the wearable sound system of FIGS. 5A-5B may incorporate the remote controller 400 adapted to operate the programmable source 120 via the wireless communication link 402 as described above for the embodiment of FIG. 4. Additionally or alternatively, at least some of the speakers 130G-130J may include a protective cover or be embedded in material(s) of the harness 300, as set forth above for the speakers 130A, 130B and the collar 110 for the embodiment of FIG. 1.

It will be appreciated by those skilled in the art that in the foregoing embodiments, the collar, the harness, and the hood constitute supporting means for removably supporting the programmable source and for supporting the speakers in areas disposed proximate to the ears of the animal so that the speakers project a sound content of the audible signals from the programmable source toward an immediate vicinity of the ears of the animal in a region located forward or around the ears. It will be understood, however, that the mounting means is not limited to a collar, a harness, or a hood, but may instead be any other type of article wearable by the animal, including ear muffs or any type of article of clothing wearable by the animal that can support the programmable source and speakers as set forth above.

By delivering the intended pre-programmed sounds to ears of an animal using a plurality of selectively disposed speakers, the wearable digital sound systems of the present disclosure provide efficient means for training or controlling of the animal. In other applications, the disclosed systems may be used in veterinary practice for implementing therapeutic procedures directed towards soothing or desensitization of the animal, as well as a form of entertainment for the animal.

Referring to some applications involving dogs, such systems may be used to teach the dogs obedience, calm excessive barkers or nervous dogs, decrease stress or agitation, or provide training for operating/behaving in environments having specific noise patterns (for example, during traveling on a plane or a railroad car). It is understood by those skilled in the art, however, that the systems disclosed herein are not limited to applications involving dogs, but may be also used with other animals, such as cats and horses.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A wearable sound system for an animal, comprising:
an article wearable by the animal;
a programmable source of audible signals removably coupled to the article; and
at least two speakers, each speaker coupled to the article in an area disposed proximate to an ear of the animal when the article is worn by the animal and adapted to project a sound content of the audible signals towards an immediate vicinity of the ear of the animal in a region located forward or around the ear.

2. A wearable sound system according to claim 1; wherein the article is a collar fastenable around a neck of the animal.

3. A wearable sound system according to claim 1; wherein the article is a hood fastenable around a head of the animal.

4. A wearable sound system according to claim 1; wherein the article is a harness fastenable around a head and body of the animal.

5. A wearable sound system according to claim 1; wherein the programmable source of audible signals is coupled to the speakers using wires embedded in the article wearable by the animal.

6. A wearable sound system according to claim 1; wherein the programmable source of audible signals is adapted for storing, playing, and deleting files embodying the audible signals.

7. A wearable sound system according to claim 6; wherein the programmable source of audible signals comprises a memory adapted for storing the files embodying the audible signals.

8. A wearable sound system according to claim 1; wherein the programmable source of audible signals comprises at least one of a means for providing manual control of the programmable source or a means for providing wireless control of the programmable source.

9. A wearable sound system according to claim 8; further comprising a remote controller adapted to operate the programmable source of audible signals via a wireless communication link.

10. A wearable sound system according to claim 1; wherein the programmable source of audible signals comprises a digital source of audible signals.

11. A wearable sound system according to claim 10; wherein the digital source of audible signals is an MP3 player.

12. A wearable sound system according to claim 1; wherein each of the speakers is embedded in a material of the article.

13. A wearable sound system according to claim 1; wherein the at least two speakers include a plurality of speakers disposed proximate to at least one ear of the animal.

14. A wearable sound system according to claim 1; wherein the audible signals comprise commands, training signals, stress-relieving signals, or a combination thereof.

15. A wearable sound system according to claim 1; wherein the article is configured to be worn by a dog, a cat, or a horse.

16. A wearable sound system for an animal, comprising:
a programmable source of audible signals;
at least two speakers; and
supporting means wearable by the animal for removably supporting the programmable source and for supporting each of the speakers in an area disposed proximate to an ear of the animal so that the speakers project a sound content of the audible signals from the programmable source toward an immediate vicinity of the ear of the animal in a region located forward or around the ear.

17. A wearable sound system according to claim 16; wherein the supporting means comprises a collar fastenable around a neck of the animal.

18. A wearable sound system according to claim 16; wherein the supporting means comprises a hood fastenable around a head of the animal.

19. A wearable sound system according to claim 16; wherein the supporting means comprises a harness fastenable around a head and body of the animal.

20. A wearable sound system according to claim 16; wherein the at least two speakers include a plurality of the speakers disposed proximate to at least one ear of the animal.

21. A wearable sound system according to claim 16; further comprising wires embedded in the supporting means for coupling the programmable source of audible signals to the speakers.

22. A wearable sound system according to claim 16; wherein the programmable source of audible signals comprises a digital source of audible signals adapted for storing, playing, and deleting files containing the audible signals.

23. A wearable sound system according to claim 16; wherein the programmable source of audible signals includes means for providing manual control of the programmable source.

24. A wearable sound system according to claim 16; wherein the programmable source of audible signals includes means for providing wireless control of the programmable source and a remote controller adapted to operate the programmable source via a wireless communication link.

25. A wearable sound system for an animal, comprising:
an article wearable by the animal;
a programmable source of audible signals removeably coupled to the article;
at least two speakers each coupled to the article in an area disposed proximate to an ear of the animal when the article is worn by the animal and adapted to project a sound content of the audible signals towards an immediate vicinity of the ear of the animal in a region located forward or around the ear; and
a remote controller adapted to operate the programmable source via a wireless communication link.

26. A wearable sound system according to claim 25; wherein the article comprises a collar fastenable around a neck of the animal.

27. A wearable sound system according to claim 25; wherein the article comprises a hood fastenable around a head of the animal.

28. A wearable sound system according to claim 25; wherein the article comprises a harness fastenable around a head and body of the animal.

29. A wearable sound system according to claim 25; further comprising wires embedded in the article wearable by the animal for coupling the programmable source of audible signals to the speakers.

30. A wearable sound system according to claim 25; wherein the at least two speakers include a plurality of the speakers disposed proximate to at least one ear of the animal.

31. A wearable sound system according to claim 25; wherein the programmable source of audible signals is a digital source of audible signals adapted for storing, playing, and deleting the files containing the audible signals.

32. A wearable sound system according to claim 25; wherein the audible signals comprise commands, training signals, stress-relieving signals, or a combination thereof.

33. A wearable sound system according to claim 25; wherein the article is configured to be worn by a dog, a cat, or a horse.
